(19) United States
(12) Patent Application Publication
(10) Pub. No.: US 2018/0005292 A1
(43) Pub. Date: Jan. 4, 2018

(54) MONITORING GOODS OFFERED FOR SALE ONLINE

(71) Applicant: WESSEX TECHNOLOGY OPTO-ELECTRONIC PRODUCTS LIMITED, Waterlooville, Hampshire (GB)

(72) Inventor: Alan Bell, Fareham (GB)

(73) Assignee: WESSEX TECHNOLOGY OPTO-ELECTRONIC PRODUCTS LIMITED, Waterlooville, Hampshire (GB)

(21) Appl. No.: 15/547,206

(22) PCT Filed: Jan. 28, 2016
(86) PCT No.: PCT/GB2016/050191

§ 371 Date: Jul. 28, 2017

(30) Foreign Application Priority Data
Jan. 28, 2015 (GB) 1501439.2
Feb. 5, 2015 (GB) 1501885.6

(51) Int. Cl. G06Q 30/06; G06Q 30/00

(52) U.S. Cl. CPC G06Q 30/0625; G06Q 30/0185

(57) ABSTRACT

A method of detecting attempts by online sellers to sell counterfeit goods on the internet, or to sell goods which they are not authorised to sell, is described. The user of a browser-enabled device when viewing a target website can determine whether the target website content is authorised or not. The browser may have a plug-in which allows the user to capture data from a target website, and send the data to a secure server which has access to or which stores data from the legitimate content owner or user. The data is then analysed to determine whether its use on the target website is authorised or legitimate, or not, and a warning or clearance message can then be sent from the secure server to the browser-enabled device to display that message to the user.

This invention relates to the detection of attempts by online sellers to sell counterfeit goods on the internet, or to sell goods which they are not authorised to sell.

WO 2012/146942 discloses a system and ways of putting it into effect designed to authenticate product or, if the product is not authentic, e.g. a counterfeit, to detect that. The system can be used to check authenticity at any point, but it requires the product to be physically present. Thus, the system is not adapted to authenticate product intended to be purchased via the Internet, as the system could only be used after the possibly counterfeit product had been purchased and delivered.

A well known and widely reported problem is that fake and counterfeit goods are sold on the internet; this causes losses to the brand owner and poses risks to the consumer as the fake goods are often not made to the same standards as the original products.

A particular challenge to the brand owner is that the websites selling these fake goods are reported by search engines without reference to their authenticity, that is a prospective purchaser, when searching for a product will type keywords into a search engine (such as Google.com), and the search engine will promote to the top of the list, websites that meet the requirements of the search engines algorithm links or have a pay per click arrangement with the search engine provider. Search engines work by continually scanning all of the available pages on the internet, collecting together words and graphical items and indexing them so that later web searches undertaken by a user will match the terms the user is looking for and listing them on a results page presented to the user; the search engine company derives its income by requiring owners of websites to pay for appearing at the top of the list presented to the user. When the search engine visits a site it reads the contents of a file called robots.txt for instruction regarding which pages may not be searched or indexed, allowing the website owner to maintain some degree of privacy on their site.

Common web browsers (such as Chrome®, Internet Explorer® or Firefox®) are built to allow extra functionality by means of plug-ins—these are downloadable programs that can modify the content of a web page, for example by blocking adverts embedded in web pages.

The brand owners can pay for services of companies like MarkMonitor.com which will run continual searches on the internet, looking for suspicious sites, and report them to the brand owners, who then need to enter complex legal proceedings to get the sites “taken down”, that is switched off. When the site is taken down, a copy site using the same text, pictures and brand owners logos can appear within hours, forcing the brand owner to start the enforcement process again.

A further problem can occur when pricing differentials exist in different markets that may be geographically close to each other. An authorised re-seller for one territory can accept orders for products to be sold to internet customers outside of their assigned territory, causing losses to the authorised seller in the second territory.

Different products exist for end-user authentication of products, such as serial number checking.

The present invention allows brand owners to counter unauthorised use of their website content (logos, text and images). Such content is already protected under copyright law but action to enforce copyright law on the internet in any particular case can be expensive to undertake.

The internet does support a range of security devices and protocols to protect and encrypt data travelling over network such as Https, but these cannot currently be used to combat the offer for sale of counterfeit or unauthorised goods.

The present invention is based on the realization that if a brand owner were able to control the use of the protected images that it owned, be it a trademark, design, or product name or even product pictures—none of which are currently adequately protected in cyberspace—then effective control of the use of these mainly graphical items, would effectively prevent fake selling, because sellers of fakes cannot easily sell a product without product pictures or the brand owner's logo. The control could be exerted over widespread geographic locations and over web pages where a logo can appear, and could assist in combating illicit or fake service provision, as practiced by phishing and fake websites for governments and banks, as well as enabling the activities of unauthorised web data aggregators to be curbed or prevented and enabling phishing to be curbed

In accordance with the present invention a brand owner's website is built to work with a plug-in or modified browser which is described below.

The brand owner website will normally carry a set of html instructions that cause the web page to be constructed in a certain way, defining colour, fonts, text, pictures (either static or moving), sound effects and external links to other sites for third party content. In accordance with one embodiment of the invention the site components (such as logos, product shots and descriptions) which are commonly misused by websites selling fake or unauthorised goods are stored on a secure server together with data describing permitted use of the protected material (called a repository in what follows) separate from the main site, and the html instructions to display such components directs the page to fetch the relevant content from the secure server.

In the simplest arrangement the plug-in allows the site user to click, for example, a logo or product picture and confirms via a message on the screen that the picture has been downloaded from the repository. A website using an unauthorised copy of the content will not be confirmed as genuine to the user and may show a warning that the site and products on it are not to be trusted.

In a further enhancement the plug-in checks the repository link with the name of the site, and the plug-in may then confirm that a particular re-seller has the permission of the brand owner to use the logo or product image.

In a further enhancement the plug-in alerts the brand owner that their material is being used on a site not authorised to sell the products referenced in the images stored in the repository, and the plug-in may also be programmed to send the user to the brand owner's main site, or to another site approved by the brand owner.

In a further enhancement the plug-in checks names and keywords on a site, and if they relate to or are a brand owner's trademark, automatically checks any displayed images to confirm these match the protected images and logos of the brand owner as held in the repository, and alerts the user of unauthorised content without needing the user to click on an image to see if it is authorised.

In a further embodiment the plug-in is built into a web browser avoiding the need for it to be separately installed.

In an alternative embodiment the search engine is programmed to check the website content for references to protected brand owner content, and then confirms the presence of links to the repository in the website, so that it only indexes and promotes sites authorised to use such content. This materially reduces the opportunity of sellers of counterfeit product to operate, as their sites simply do not get selected, nor are links to them displayed to the potential customer.

In a further embodiment the images of trademarks, products and other pictorial items that the Brand owner seeks to protect are tagged with a digital number or similar identifier. The image to be protected is rendered by the browser as it is currently, this gives the advantage that the page shown to the user updates uniformly, as the source material for the web page originates from the same server. In this embodiment the plug-in checks the graphical elements that may contain protected content, and, if these contain tags, then the plug-in sends the details of the tag, the computer's location, and the address of the web page to the repository in order to confirm that the use of the protected content is permitted; if so, the content remains displayed.

If not the browser plug-in can inform the user by various different means. These may include:
In response to a mouse click on the graphic. indicate “OK” or “bad” or other messages
In response to a mouse click leave the logo unmodified, or else place a graphical indicator within the or near the graphical content such as a tick for approval or a “skull and crossbones” to indicate unauthorised image use.
Perform either of the above automatically without the need for a mouse click.
Invite the user to transfer to a website where the graphical item may be used in accordance with the rights owner of the graphical image.

In a further enhancement the plug-in checks the “tags” and text content of a website and if the website contains trademark protected words, then the plug-in checks the graphical items (tagged or not) for similarity to protected images held in the repository corresponding to the protected words. Pending the outcome of this verification the user is advised of the permitted use.

In a further enhancement of the above a “fair use” outcome is reported if the site hosting the graphical item is claiming this right and the image owner has agreed this, for example a news website may use a relevant logo as part of reporting a news story.

The description above is directed to a way of putting the invention into practice where the browser is modified or a plug-in is used. An alternative approach to achieve the same effects is to use a separate program which monitors, and if necessary modifies, the data flowing between the browser on the user's computer or terminal and the server hosting the brand owner's website.

Although the invention is envisaged as being applicable to the offering for sale of goods via the internet, it can clearly be applied in appropriate cases to offers for the sale of services. In all cases the invention acts to detect and if desired restrict the access to unauthorised sites or those selling counterfeit products, so reducing the potential for diversion of business from the legitimate brand owner, and potentially effectively rendering the illegitimate trade unfindable by a prospective customer.

The following is a description, by way of example, showing how the invention described above may be implemented in greater detail, both from a technical viewpoint and from a business model viewpoint. In this description, the following terms have the meaning ascribed to them in the table below:

TABLE

| Term | Meaning |
|---|---|
| Brand owner | Company or individual wishing to protect their |
| | intellectual property rights |
| Product | Selling a product intended for 1 geographic area into a |
| diversion | higher cost area for example selling goods intended for |
| | the Mexico market into the United States. |
| Robots.txt | This is a text file that is found on the index page of each |
| | website, it is designed to give direction to search engines |
| Spoof | A database holding data that allows detection of spoof |
| Detection | sites, typically trademark names, protected logos and |
| dataset | keywords used in association with trademarks. |
| Spoof site | A website that pretends to be another site, normally a |
| | financial institution, with the intent of acquiring data or |
| | money from the User or the institution it is pretending to |
| | represent |
| Trademark- | A working name which might be used as a trade mark for |
| Locker | the system |
| Trusted Image | A database holding information describing protected |
| dataset | images, where they are stored, and the pages they can |
| | be displayed on |
| User | Person using phone, tablet or computer to purchase |
| | goods or services using the internet |

### Overview

TrademarkLocker fights counterfeiting by placing controls on which websites use trademarks and copyright protected data. Websites selling counterfeit goods use misappropriated graphics such as logos and product pictures to create a false shop front to mislead on-line buyers. TrademarkLocker protects graphical items including trademarks, logos, product pictures and other advertising material; protection can be extended to audio and video content. TrademarkLocker monitors the use of logos and other protected images to make the User and the brand owner aware of the fake nature of the site.

### TrademarkLocker Implementation

The implementation described requires no major technical development and many companies could implement a solution in a matter of weeks. Commercialisation may however best be done by a major web company.

If implemented well, TrademarkLocker changes the way the internet operates, many existing business models, for example pay per click advertising, news aggregation and search engines will be more trusted. This is because the brand owner will be able to control where their logos appear on the Internet, and if executed correctly, logos and trademarks will be more powerful than cookies for customer tracking and brand/customer relationship building. Currently a website owner decides which cookies are used on a site and how the tracking data is used. TrademarkLocker places the “cookie” anywhere the brand owner's logo or protected image is displayed. Tracking data previously limited to the site owner will be available to the brand owner, whether the data is from an official site, an authorised reseller, or a knock-off site using the brand owner's protected material.

TrademarkLocker, if implemented correctly, will create Web2.1—a more trustworthy and honest version of Web2.0.

The technical challenges are mainly that of scale—creating sufficient data bandwidth for the authentication process, and engaging major banks and other financial institutions to use the technology, ensuring that TrademarkLocker becomes the industry standard.

### How TrademarkLocker Works

### Overview

TrademarkLocker regards sites as “Approved” or “Non-approved”.

### Approved Sites

An approved site carries verifiable hyperlinks to a brand owner's logo and other protected material. Details of these links and sites are stored in the Trusted Image dataset on the TrademarkLocker server. Browsers and search engines can access this information; search engine results can be qualified knowing sites are authorised to carry these logos, browsers can likewise show that the site is permitted to promote or sell the indicated goods.

### Non-Approved Sites

Non-approved sites are sites that carry keywords and copies of the approved graphics but without authorisation from the brand owner. In this case the browser looks for keywords which may be protected (for example “delta” and “airlines”) then sends this data to the Spoof Detection set which downloads graphics relating to the key words, then performs a local image comparison between the returned graphics and the graphics on the webpage.

### TrademarkLocker Organisation

TrademarkLocker will be a private organisation that assumes a judicial role, it will determine, by software, who has rights to use Copyright and Trademark protected material on the Internet. It will need to be transparent, have clear oversight, dispute resolution and to be useful must be perceived as a trusted organisation for administration of intellectual property rights.

### TrademarkLocker Revenue

TrademarkLocker will be able to source revenue in the following ways:
Brand owners seeking protection from spoofing, counterfeits and product diversion;
Sale of User analytic data back to the brand owners.
The public safety role in reducing sale of counterfeit goods may allow it to raise money from government.
Charge 3^{rd} party search engines for authentication data for a Protected site
Creation of a trusted site search engine based on Protected sites.
Extension of the TrademarkLocker services to government approvals, in the UK, for example a gas heating installer needs to be “CORGI” registered, this indicates that the firm and the individual are certified safe to do this type of work. TrademarkLocker can be used to control the appearance of the “CORGI” logo on websites.
Replace/Augment paper certification, Paper certificates are used two ways in industry, employee qualifications and to show a company is accredited to do a particular type of work—i.e. ISO9001 certification. TrademarkLocker can be adapted to carry images of these certificates and allow a download on demand for those wishing to confirm the validity of these paper certificates.
Card payment companies (MasterCard, Visa, PayPal etc) can be offered Protection by allowing the payment software to use the browser plug-in to determine whether the site is Approved or not, also whether the User has disabled the extension, advising the User that they are in a “buyer beware”, untrustworthy environment.

### TrademarkLocker Server

The TrademarkLocker server contains two main databases
The Trusted Image dataset is used to ensure that only brand owner approved websites can carry their protected images. It contains the unique names of the protected graphic files, with the location where they are held, and the URL of the page where the protected graphic can be displayed and the scope of protection.
The Spoof Detection dataset contains representative images of the protected graphics and associated keywords.

The brand owner has a portal to control, upload and update these images and to manage analytics showing where the images are being used and by whom. The brand owner will also be required to provide an electronic copy of their trademark registration data to be used for trademark dispute resolution.

Search engines indexing a site can test the “robots.txt” file to see if the images used on the site can be authenticated by TrademarkLocker. If so the search engine follows the process for checking the graphics on a protected site, the search engine can then show in its search results that a particular site is authorised to carry the protected content.

### Brand Owner Web Developer

The web developer for the brand owner assigns unique filenames to the protected images controlled by the TrademarkLocker server. Each uniquely named graphic file name is associated with its intended webpage and normal file path. This set of data is transferred to the Trusted Image dataset. The browser or the search engine confirms, for each protected image found on a web page, that the image is being displayed on the correct page, and the file path for the protected image is correct—this stops spoof sites using protected images.

The brand owner web developer also edits the robots.txt file on the index page of the protected website to define the URL for the TrademarkLocker server. It is proposed that the robots.txt file includes:

“Trademark repository=www.trademarklocker.com”

The brand owner web developer is responsible for uploading the data needed for the Spoof Detection dataset, this typically includes trademarks, and closely aligned words, plus the template images for the brand owner's logo.

### Browser Extension

The browser extension checks the site robots.txt file to determine whether the site is protected by TrademarkLocker. If the site is protected by TrademarkLocker then the data relating to the graphics are sent to TrademarkLocker for checking, these include the address of the page hosting the link, and the file path of the graphic. TrademarkLocker will check that the combination of links and the graphic and the geographic location of the User's computer are as intended by the brand owner and that the site is legitimate. The images are displayed as normal.

The browser extension can also, pending permissions, send useful data about the User and the device hosting the web browser to the TrademarkLocker server for use by the brand owner. A brand owner with a significant number of wholesalers and distributors can collect analytic data across this entire supply chain, simply by granting permission to their approved suppliers to use their logo. A reseller with significant web traffic from outside their geographic area may be participating in product diversion.

If the site is not protected, the browser extension executes a Spoof Detection function by sending the visible words and search tags to the TrademarkLocker site to retrieve reference images of logos associated with these words.

The browser extension compares the graphical images from the site to the downloaded images and makes a decision that the images should be protected and that the site is using the images without the permission of the brand owner. The browser extension notifies the User that the site is using content belonging to someone else. At the discretion of the brand owner the browser can blank the unauthorised images, or annotate them, or offer a link to the brand owner's site.

### Privacy

Data protection rules and freedom of speech advocates will require that the browser extension can be disabled, this is not a problem, because most people will want to know that a website is legitimate, if the browser is not using the browser extension, the site will be rendered normally, but the browser will carry a warning showing that TrademarkLocker is Disabled.

### Development Phases

### Phase A—Creation of the Trusted Image Dataset

The trusted image dataset will allow search engines to be certain that any particular website has permission to use a logo and its associated trademark. This allows users of the search engine to perform trusted searches, knowing that sites carrying the logos are allowed to sell the goods and services carried on the site.

### Phase B—Simple Browser Extension

The simple browser extension is able to use the “Trademark Repository” term to validate graphical items present on the web pages are there with the permission of the brand owner. This gives the User confidence that merchandise is unlikely to be counterfeit, and it gives the brand-owner analytics for their complete supply chain, it will generate indications of websites performing grey market diversion.

### Phase C—Complex Browser Extension

The Complex Browser Extension undertakes a text analysis of unprotected pages and a comparison of the related images from the TrademarkLocker server and those from the suspect site. This complex browser extension allows the User to know that the images presented are spoofed, and that they are at risk. It also gives brand owners awareness of which sites are misusing their images or other content. The Complex Browser Extension will need to be able to undertake character recognition on Spoof site pages that are presented in Jpeg or other graphical formats.

An alternative implementation the Complex Browser Extension sends the address of the potentially infringing images to the TrademarkLocker server for comparison. This removes the need to send adult content to a User's computer when protecting content from the adult entertainment industry or monitoring revenge porn.

### Deployment Phases

### Phase 1—Banks and Financial

British banks suffered phishing losses of £30 million (US$48 million) in the first half of 2014. These organisations have few logos (compared to say a luxury goods brand), a small set of keywords and a customer base that will normally comply with bank requirements to make their on-line experience safe.

Using banks as Phase 1 customers would create a large number of Users with installed browser extensions, whilst keeping the data content of the Trademark server manageable.

The deployment of TrademarkLocker can do more than protect large corporations, it may generate negative reactions; responses such as “corporations taking over the internet” can be expected. It may be of value to engage with other smaller organisations at this stage to help Users understand that rights protection applies outside of big corporations. Particular organisations that may be engaging at this stage include www.theoatmeal.com.

Phase 2—High value brands

A small number of high value brands would be the target for the 2^{nd} Phase.

### Later Phases

Later phases will open the system to smaller brands; examples of some other Users follow:

### Data Aggregators

There is an ongoing dispute between www.funnyjunk.com and comic website www.theoatmeal.com. TrademarkLocker would allow the owner of copyright in the disputed pages to assert their rights, both to the search engines and to the viewers of www.funnyjunk.com.

### Revenge Porn

TrademarkLocker could be used to challenge so called “revenge porn” sites, using the keywords (normally a victim's name and email address) associated with the objectionable images, to make revenge porn viewers aware that their use of the revenge porn sites is known to the victim support associations.

### Email Protection

Extensions to common email programs such as Outlook containing the TrademarkLocker functionality could be made available in a further layer of protection against phishing.

### Consequences

TrademarkLocker will alter some of the existing Internet business models. Predicting these changes is difficult, but below are a few observations.

### Copyright Repository

Web 2.0 has been characterised as “what's yours is mine” and an attitude of if it's on the web then I can use it. This has been seen in Users and some web companies. The existence of an online repository showing IP ownership will give rise to restrictions on what companies can use, because the ownership of material is now searchable, and the monetisation of information of data that can be shown to belong to others will be subject to challenge. The business models of search engines, and listing companies such as Hotels.com will be challenged.

### Political Control of Images

In the UK there is an example of Copyright being used to suppress adverse political messages. A photo of the current Conservative party leaders in their formative years, dressed in the distinctive garb of the Bullingdon Club, cannot be shown because of Copyright restrictions. Such restrictions may become more easily enforceable using the mechanisms provided by TrademarkLocker.

In the accompanying drawings:

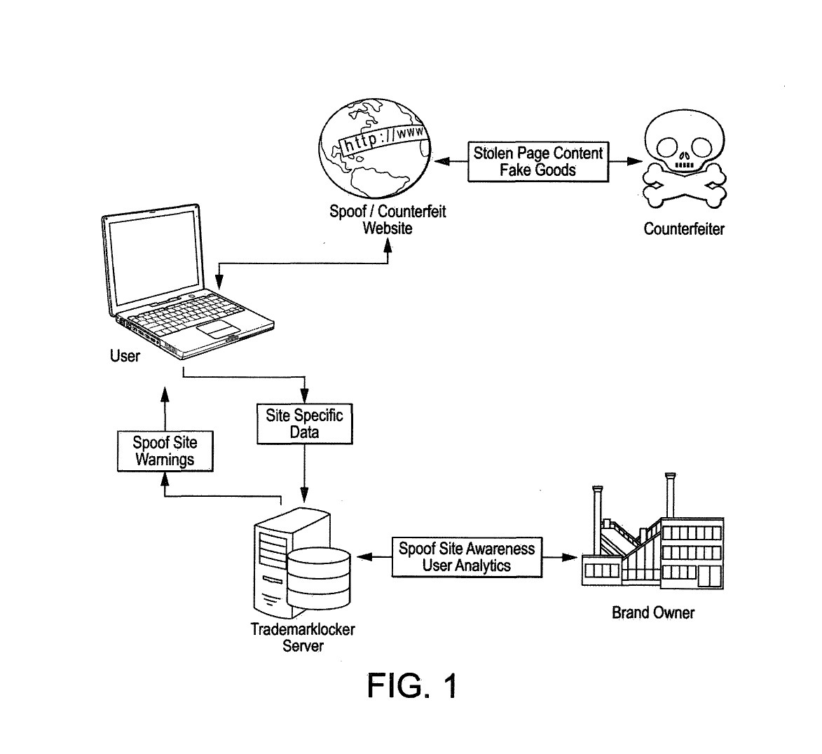

FIG. 1 shows diagrammatically how the method of the invention may be put into effect;

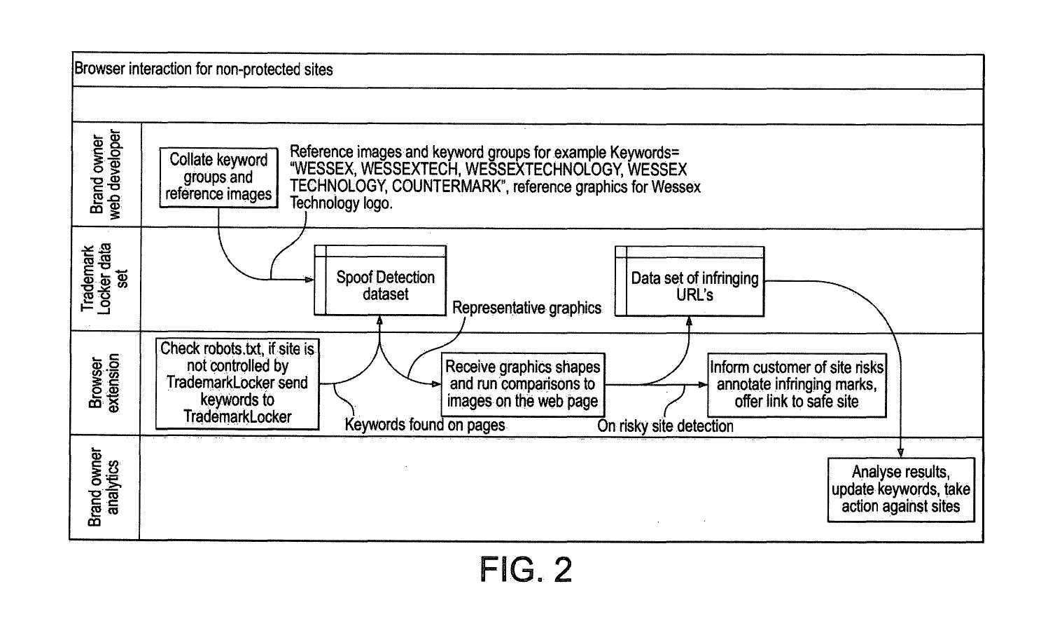

FIG. 2 is a tabular diagram showing the interaction pattern for non-protected sites; and

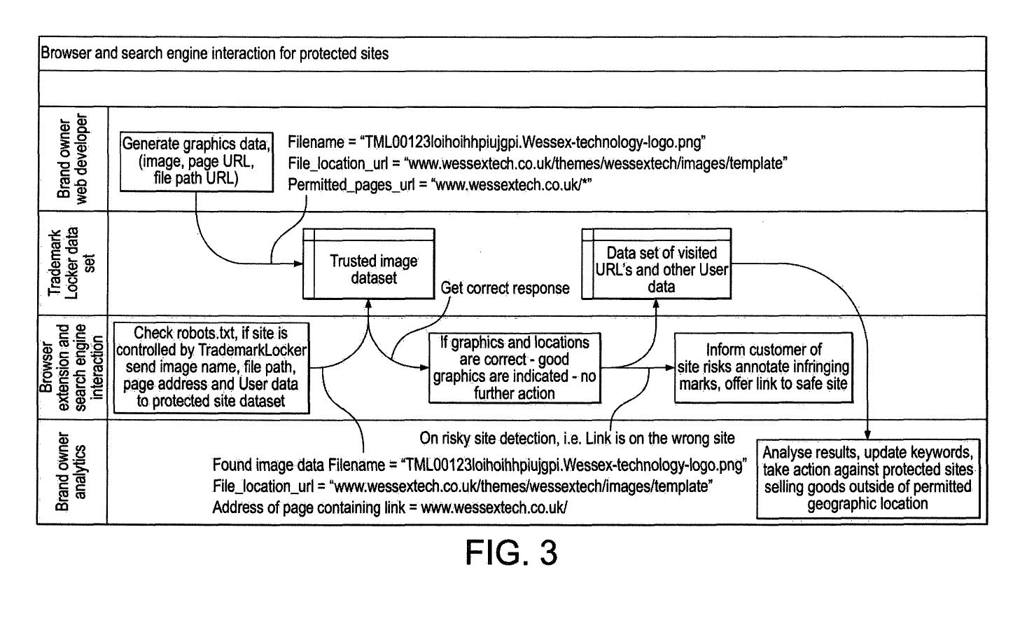

FIG. 3 is a tabular diagram showing the interaction pattern for protected sites.

If the material to be protected, and the misuse of which is to be detected, is a company logo, this may have an identifier in the original genuine stored version of the logo such as:

<imgsrc=“/themes/wessextech/images/template/TML00123loihoihhpiujgpi.Wessex-technology-logo.png” alt=“Wessex Technology OEP Ltd.” Height=“69” width=“137”>

### Trusted Image Dataset

The following text is an example of the type of data that would be held for the above item on the trusted image dataset.

Filename=“TML00123loihoihhpiujgpi.Wessex-technology-logo.png”
File_location_url=“www.wessextech.co.uk/themes/wessextech/images/template/”
Permitted_pages_url=“www.wessextech.co.uk/*”

### Spoof Detection Dataset

The following text is an example of the type of data that would be held for the above item on the spoof detection dataset.

### Keywords=“WESSEX,WESSEXTECH,WESSEXTECHNOLOGY,WESSEX TECHNOLOGY,COUNTERMARK”

As well as a reference graphic corresponding to the logo in question.

1. A method of authenticating material found by a user of a browser-enabled device on a target website with a view to determining whether the target website content is authorised or not, which comprises capturing data from a target website, sending the data from the a browser-enabled device to a secure server which has access to or which stores data from the legitimate content owner or user, analysing the data sent to determine whether its use on the target website is authorised or legitimate, or not, and sending a warning or clearance message from the secure server to the browser-enabled device to display that message to the user.

2. A method according to claim 1 where the browser-enabled device is a pc, tablet, laptop or smart phone, and where the browser installed in the device has a plug-in enabling the authentication method to be carried out.

3. A browser plugin designed and adapted to operate a browser on a browser-enabled device to carry out the method of claim 1.
